(19) United States
(12) Patent Application Publication
(10) Pub. No.: US 2002/0126578 A1
(43) Pub. Date: Sep. 12, 2002

(54) Curved aperture protection sensor

(75) Inventors: Eli Gal, Ramat-Gan (IL); Uri Agam, Petach-Tikva (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SENSOTECH LTD., Or-Yehuda (IL)

(21) Appl. No.: 10/060,007

(22) Filed: Jan. 28, 2002

Related U.S. Application Data
(60) Provisional application No. 60/264,805, filed on Jan. 29, 2001.

(51) Int. Cl. G01S 15/93

(52) U.S. Cl. 367/99; 367/909

(57) ABSTRACT

Safety apparatus and method for sensing the presence of an object in a safety zone including at least one ultrasonic transducer having an asymmetrical transmission field and received signal processing circuitry operative to receive signals reflected from objects within the asymmetrical transmission field and to discard signals lying outside an asymmetrical detection field lying within the asymmetrical transmission field and defining the safety zone.

### REFERENCE TO CO-PENDING APPLICATION

Applicants hereby claim priority of U.S. Provisional Patent Application Serial No. 60/264,805, filed Jan. 29, 2001, entitled “Contour Protection”.

### FIELD OF THE INVENTION

The present invention relates to safety apparatus which finds application, for example, in vehicle trunks, automatic door operating devices and machine tools.

### BACKGROUND OF THE INVENTION

The following U.S. Patents are considered to represent the state of the art: U.S. Pat. Nos. 4,029,176; 4,590,410; 4,779,240; 4,976,337; 5,001,557; 5,149,921; 5,276,391; 5,313,834; 5,319,611; 5,337,289; 5,339,075; 5,341,344; 5,373,482; 5,390,152; 5,412,297; 5,420,430; 5,467,072; RE 33,668; RE 30,719.

### SUMMARY OF THE INVENTION

The present invention seeks to provide improved safety apparatus.

There is thus provided in accordance with a preferred embodiment of the present invention safety apparatus for sensing the presence of an object in a safety zone, which includes at least one ultrasonic transducer having an asymmetrical transmission field and received signal processing circuitry operating to receive signals reflected from objects within the asymmetrical transmission field and for discarding signals lying outside an asymmetrical detection field lying within the asymmetrical transmission field and defining the safety zone.

There is also provided in accordance with a preferred embodiment of the present invention a safety method for sensing the presence of an object in a safety zone. The method includes providing at least one ultrasonic transducer having an asymmetrical transmission field and operating a received signal processing circuitry for receiving signals reflected from objects within the asymmetrical transmission field and for discarding signals lying outside an asymmetrical detection field lying within the asymmetrical transmission field and defining the safety zone.

Further in accordance with a preferred embodiment of the present invention the safety zone has boundaries, some of which are defined by the asymmetrical transmission field and some of which are defined by the asymmetrical detection field.

Still further in accordance with a preferred embodiment of the present invention the ultrasonic transducer includes a plurality of ultrasonic transducers.

Additionally in accordance with a preferred embodiment of the present invention the ultrasonic transducer includes at least one flexible transducer whose shape at least partially determines the configuration of the asymmetrical transmission field.

Further in accordance with a preferred embodiment of the present invention the asymmetrical detection field changes in configuration over time and the boundaries, which are defined by the asymmetrical transmission field, remain generally static over time and the boundaries, which are defined by the asymmetrical detection field, change over time.

Additionally in accordance with a preferred embodiment of the present invention the safety zone has boundaries, some of which are defined by the at least one ultrasonic transducer and some of which are defined by the received signal processing circuitry.

There is further provided in accordance with a preferred embodiment of the present invention apparatus for sensing the presence of an object in a protected zone including at least one ultrasonic transducer having an asymmetrical transmission field and received signal processing circuitry which operates to receive signals reflected from objects within the asymmetrical transmission field and to discard signals lying outside an asymmetrical detection field lying within the asymmetrical transmission field, and defining the protected zone. The protected zone includes boundaries some of which are defined by the asymmetrical transmission field and some of which are defined by the asymmetrical detection field.

There is provided in accordance with yet another preferred embodiment of the present invention apparatus for sensing the presence of an object in a protected zone, which includes at least one ultrasonic transducer having a transmission field and received signal processing circuitry which operates to receive signals reflected from objects within the transmission field and to discard signals lying outside a detection field lying within the transmission field, and defining the protected zone. The protected zone includes a boundary, part of which is defined by the transmission field and part of which is defined by the detection field.

Further in accordance with a preferred embodiment of the present invention the ultrasonic transducer includes a plurality of ultrasonic transducers.

Still further in accordance with a preferred embodiment of the present invention the ultrasonic transducer includes at least one flexible transducer whose shape at least partially determines the configuration of the asymmetrical transmission field.

Additionally in accordance with a preferred embodiment of the present invention the asymmetrical detection field changes in configuration over time.

Further in accordance with a preferred embodiment of the present invention the asymmetrical detection field changes in configuration over time and wherein the boundaries which are defined by the asymmetrical transmission field remain generally static over time and the boundaries, which are defined by the asymmetrical detection field, change over time.

### BRIEF DESCRIPTION OF THE DRAWINGS

The present invention will be understood and appreciated more fully from the following detailed description, taken in conjunction with the drawings in which:

FIGS. 1A, 1B and 1C are simplified pictorial illustrations of safety apparatus constructed and operative in accordance with a preferred embodiment of the present invention and providing time varying ultrasonic sensing in an automotive context;

FIG. 2 is an illustration of the asymmetrical transmission field and safety zone defined by one of the ultrasonic transducers in FIGS. 1A, 1B and 1C, associated with a transmission signal source and received signal processing circuitry;

FIG. 3 is a simplified pictorial illustration of the safety apparatus of FIG. 1 associated with a sun roof of a vehicle; and

FIG. 4 is a simplified flow chart illustrating the operation of the invention.

### DETAILED DESCRIPTION OF PREFERRED EMBODIMENTS

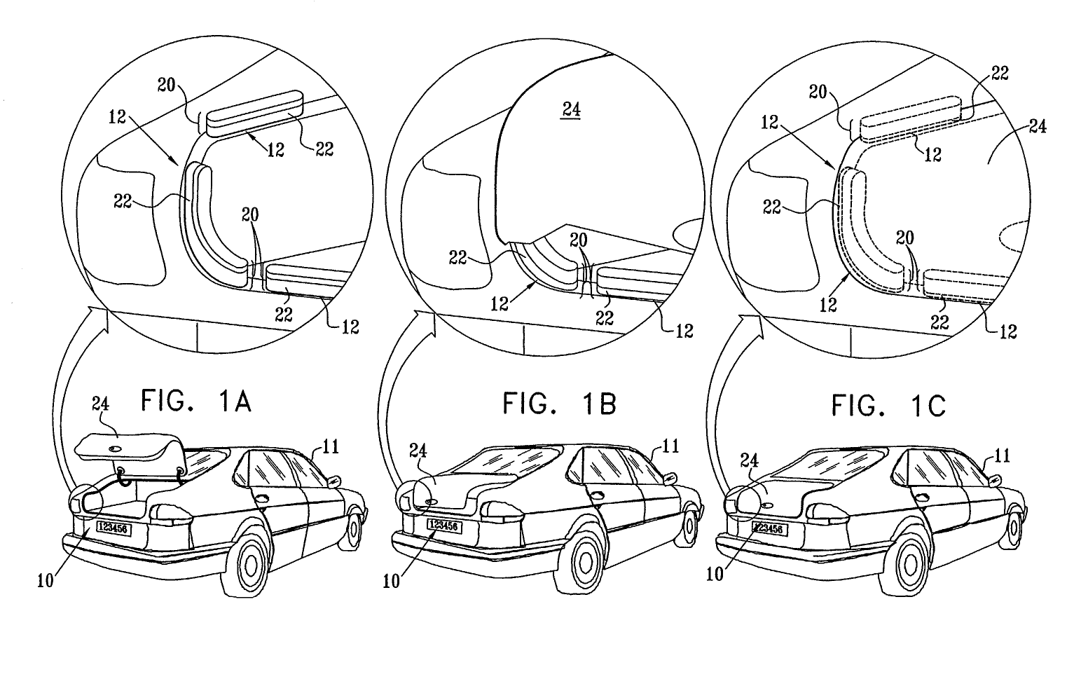

Reference is now made to FIGS. 1A, 1B and 1C, which are simplified pictorial illustrations of safety apparatus constructed and operative in accordance with a preferred embodiment of the present invention and providing time varying ultrasonic sensing in an automotive context. As seen in FIG. 1A, safety apparatus is associated with a trunk 10 of a vehicle 11, in order to prevent inadvertent closure of the trunk onto the hand or other appendage of a user.

In the example illustrated in FIGS. 1A-1C, a plurality of ultrasonic transducers 12 are mounted on the rim of the trunk 14 of vehicle 10. The transducers are preferably formed of PVDF, such as Piezoflex TM, commercially available from Airmar Technology Corporation, of Milford, N.H., U.S.A.

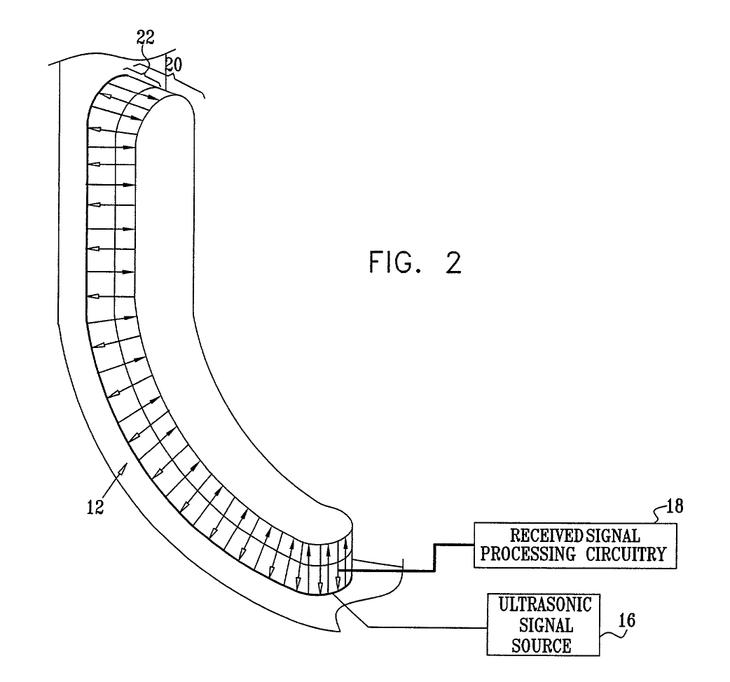

Reference is additionally made to FIG. 2, which is an illustration of the asymmetrical transmission field and safety zone defined by one of the ultrasonic transducers in FIGS. 1A, 1B and 1C, associated with a conventional ultrasonic signal source 16 and conventional received signal processing circuitry 18.

As seen in FIG. 2, preferably, each of transducers 12 is a flexible transducer and has an asymmetric transmission field 20. The ultrasonic signal processing circuitry 18 is operative to receive signals reflected from objects within the asymmetrical transmission field 20 and to discard signals lying outside an asymmetrical detection field lying within the asymmetrical transmission field 20 and defining a safety zone 22.

It is appreciated that the boundaries of the asymmetrical transmission field remain generally static over time and the boundaries of the asymmetrical detection field typically change in configuration over time.

It is seen from a consideration of FIGS. 1A-1C and 2 that the ultrasonic transmission field 20 of each of transducers 12 is preferably a well defined region overlying each transducer 12. The safety zone 22 defined within region 20 by the signal processing circuitry 18 is also a well defined region, overlying each transducer 12 but not extending to cover the entirety of region 20. It is appreciated that the extent that region 22 fills region 20 may be defined statically or dynamically by the signal processing circuitry.

Dynamic variation in the extent of region 22 may be desirable in order to provide protection in a region where the presence of an object may involve a safety issue. For example, when a trunk lid is fully open, there is little concern that the presence of the object, such as a human hand in the vicinity of the lid or of the trunk rim could constitute a safety hazard. However, when the trunk is nearly closed, the presence of a human hand in the vicinity of the lid or of the trunk rim could constitute a safety hazard. Accordingly the extent of the safety zone is preferably variable as a function of the position of the trunk lid.

FIGS. 1B and 1C show dynamic reduction in the extent of safety region 22. When the trunk is fully opened, the region 22 is at a maximum extent and preferably fully or nearly fully fills region 20. As the trunk lid 24 approaches closure, the extent of region 22 is reduced, as seen in FIG. 1B. When the trunk lid 24 is completely closed, the extent of region 22 may be reduced to nothing or to a very small extent.

It is appreciated that some or all of transducers 12 may alternatively be located on a rim or other surface of the trunk lid 24.

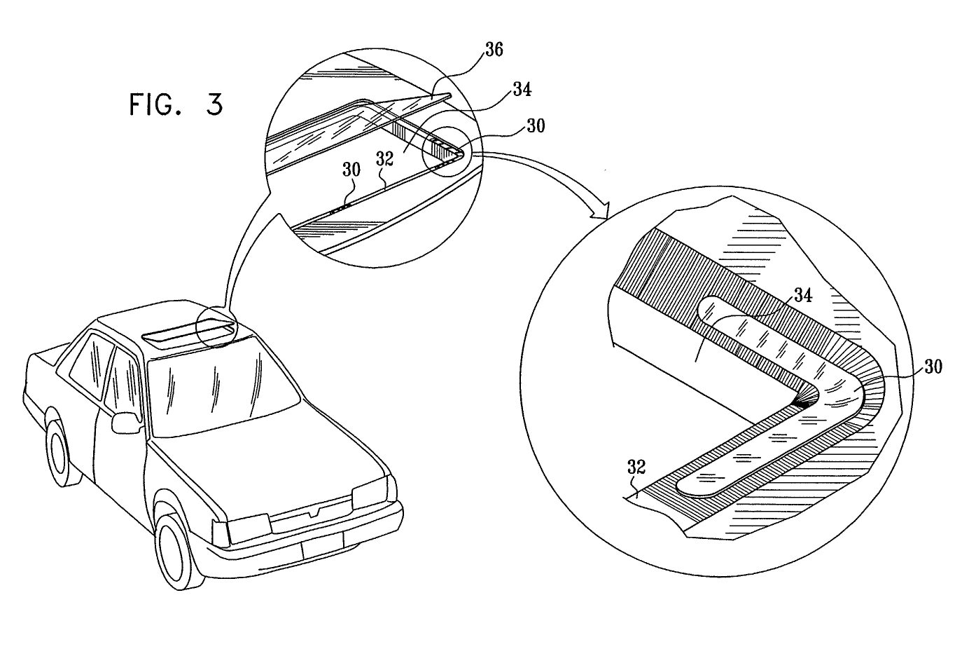

Reference is now made to FIG. 3, which is a simplified pictorial illustration of the safety apparatus of FIGS. 1A-1C and 2, associated with a sun roof of a vehicle. Here ultrasonic transducers 30 are located on a rim 32 of a sun roof opening 34. It is appreciated that some or all of ultrasonic transducers 30 may alternatively be located on a rim or other surface of a sun roof window 36. It is noted that a single transducer 30 may be bent in multiple dimensions, as shown.

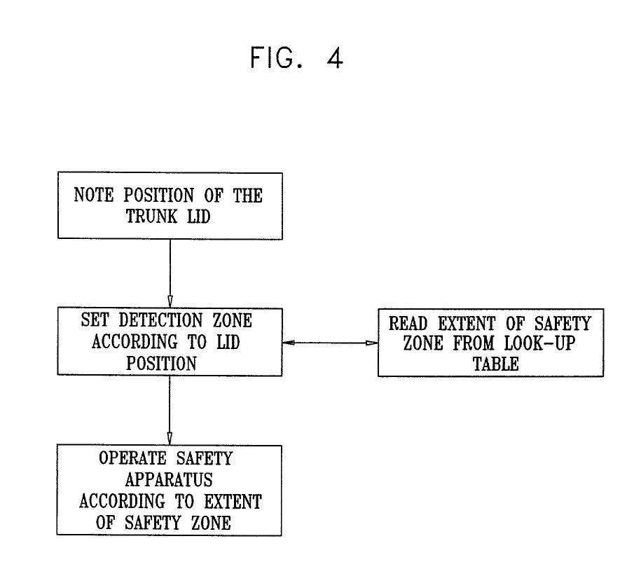

Reference is now made to FIG. 4, which is a flowchart illustrating a preferred mode of operation of the invention, providing dynamic variation in the extent of the safety zone provided by the safety apparatus of the present invention. For the sake of clarity, the flowchart is presented in the context of a vehicle trunk, it being appreciated that similar functionality may be applied to any suitable configuration, such as automatic door operating devices and machine tools.

At each position of the trunk lid relative to the trunk rim, the position of the trunk lid is noted and a predefined safety zone extent is retrieved from a look-up table or similar information source. The predefined safety zone extent may be fixed or learned in the course of a suitable conventional type of learning process and stored in the look-up table. The ultrasonic transducer and the received processed signal are operated in accordance with the appropriate predefined safety zone extent. As the position of the trunk lid relative to the trunk rim changes, the relevant extent of the safety zone may change accordingly, resulting in a corresponding change in the operational parameters of the ultrasonic transducer and the received processed signal.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. Safety apparatus for sensing the presence of an object in a safety zone comprising:
at least one ultrasonic transducer having an asymmetrical transmission field; and
received signal processing circuitry operative to receive signals reflected from objects within said asymmetrical transmission field and to discard signals lying outside an asymmetrical detection field lying within said asymmetrical transmission field and defining said safety zone.

2. Safety apparatus according to claim 1 and wherein said safety zone has boundaries, some of which are defined by said asymmetrical transmission field and some of which are defined by said asymmetrical detection field.

3. Safety apparatus according to claim 1 and wherein said at least one ultrasonic transducer comprises a plurality of ultrasonic transducers.

4. Safety apparatus according to claim 2 and wherein said at least one ultrasonic transducer comprises a plurality of ultrasonic transducers.

5. Safety apparatus according to claim 1 and wherein said at least one ultrasonic transducer includes at least one flexible transducer whose shape at least partially determines the configuration of said asymmetrical transmission field.

6. Safety apparatus according to claim 2 and wherein said at least one ultrasonic transducer includes at least one flexible transducer whose shape at least partially determines the configuration of said asymmetrical transmission field.

7. Safety apparatus according to claim 1 and wherein said asymmetrical detection field changes in configuration over time.

8. Safety apparatus according to claim 2 and wherein said asymmetrical detection field changes in configuration over time and wherein said boundaries which are defined by said asymmetrical transmission field remain generally static over time and said boundaries which are defined by said asymmetrical detection field change over time.

9. Safety apparatus according to claim 1 and wherein said safety zone has boundaries, some of which are defined by said at least one ultrasonic transducer and some of which are defined by said received signal processing circuitry.

10. A safety method for sensing the presence of an object in a safety zone comprising:
providing at least one ultrasonic transducer having an asymmetrical transmission field; and
operating a received signal processing circuitry for receiving signals reflected from objects within said asymmetrical transmission field and for discarding signals lying outside an asymmetrical detection field lying within said asymmetrical transmission field and defining said safety zone.

11. A safety method according to claim 10 and wherein said safety zone has boundaries, some of which are defined by said asymmetrical transmission field and some of which are defined by said asymmetrical detection field.

12. A safety method according to claim 10 and wherein said at least one ultrasonic transducer comprises a plurality of ultrasonic transducers.

13. A safety method according to claim 11 and wherein said at least one ultrasonic transducer comprises a plurality of ultrasonic transducers.

14. A safety method according to claim 10 and wherein said at least one ultrasonic transducer includes at least one flexible transducer whose shape at least partially determines the configuration of said asymmetrical transmission field.

15. A safety method according to claim 11 and wherein said at least one ultrasonic transducer includes at least one flexible transducer whose shape at least partially determines the configuration of said asymmetrical transmission field.

16. A safety method according to claim 10 and wherein said asymmetrical detection field changes in configuration over time.

17. A safety method according to claim 11 and wherein said asymmetrical detection field changes in configuration over time and wherein said boundaries which are defined by said asymmetrical transmission field remain generally static over time and said boundaries which are defined by said asymmetrical detection field change over time.

18. A safety method according to claim 10 and wherein said safety zone has boundaries, some of which are defined by said at least one ultrasonic transducer and some of which are defined by said received signal processing circuitry.

19. Apparatus for sensing the presence of an object in a protected zone comprising:
at least one ultrasonic transducer having an asymmetrical transmission field; and
received signal processing circuitry operative to receive signals reflected from objects within said asymmetrical transmission field and to discard signals lying outside an asymmetrical detection field lying within said asymmetrical transmission field and defining said protected zone, said protected zone having boundaries, some of which are defined by said asymmetrical transmission field and some of which are defined by said asymmetrical detection field.

20. Apparatus for sensing the presence of an object according to claim 19 and wherein said at least one ultrasonic transducer comprises a plurality of ultrasonic transducers.

21. Apparatus for sensing the presence of an object according to claim 19 and wherein said at least one ultrasonic transducer includes at least one flexible transducer whose shape at least partially determines the configuration of said asymmetrical transmission field.

22. Apparatus for sensing the presence of an object according to claim 19 and wherein said asymmetrical detection field changes in configuration over time.

23. Apparatus for sensing the presence of an object according to claim 19 and wherein said asymmetrical detection field changes in configuration over time and wherein said boundaries which are defined by said asymmetrical transmission field remain generally static over time and said boundaries which are defined by said asymmetrical detection field change over time.

24. Apparatus for sensing the presence of an object in a protected zone comprising:
at least one ultrasonic transducer having a transmission field; and
received signal processing circuitry operative to receive signals reflected from objects within said transmission field and to discard signals lying outside a detection field lying within said transmission field and defining said protected zone, said protected zone having a boundary, part of which is defined by said transmission field and part of which is defined by said detection field.

25. Apparatus for sensing the presence of an object according to claim 26 and wherein said at least one ultrasonic transducer comprises a plurality of ultrasonic transducers.

26. Apparatus for sensing the presence of an object according to claim 24 and wherein said at least one ultrasonic transducer includes at least one flexible transducer whose shape at least partially determines the configuration of said asymmetrical transmission field.

27. Apparatus for sensing the presence of an object according to claim 24 and wherein said asymmetrical detection field changes in configuration over time.

28. Apparatus for sensing the presence of an object according to claim 24 and wherein said asymmetrical detection field changes in configuration over time and wherein said boundaries which are defined by said asymmetrical transmission field remain generally static over time and said boundaries which are defined by said asymmetrical detection field change over time.
